(19) United States
(12) Patent Application Publication
(10) Pub. No.: US 2011/0214519 A1
(43) Pub. Date: Sep. 8, 2011

(54) FORCE CONVERTER

(76) Inventor: FRED WARREN JESSEE, CALGARY (CA)

(21) Appl. No.: 12/716,998

(22) Filed: Mar. 3, 2010

(51) Int. Cl. F16H 33/20

(52) U.S. Cl. 74/61

(57) ABSTRACT

This invention relates to a new device that converts rotary motion to a unidirectional force by varying the speed of rotation of a plurality of masses that rotate in apposing directions around a common axes of rotation and are perpendicular to that axes. This invention also provides a means of support for said device. It also provides for a means of controlling the relative speed of the masses as they rotate in opposite directions.

### PRIOR INVENTIONS

| PATENT | DATE | INVENTOR |
|---|---|---|
| 4,712,439 | December 1987 | North |
| 4,770,063 | September 1988 | Mundo |
| 5,054,331 | October 1991 | Rogers |
| 3,584,515 | June 1991 | Matyas |
| 5,890,400 | April 1999 | Oades |

### BACKGROUND OF THE INVENTION

1. Field of the Invention

This invention in general related to a class of devices, which utilize the centrifugal force produced by a plurality of rotating masses to produce unbalanced centrifugal forces which act in one direction.

2. Description of Prior Art

The present method to provide unbalanced force uses a mechanical means to move the masses as they rotate around a center of axes. Said masses are moved closer to and farther away from said center of axes to proved unbalanced centrifugal forces. Mechanical means are used to rotate these devices to convert rotary motion into unidirectional motion. The past devices are very heavy and require external power to drive them.

### SUMMARY OF THE INVENTION

The invention in this application produces unbalanced centrifugal force, not by varying the distance of the masses from the center of rotation but by varying the speed of rotation of the masses as they rotate around said center of axes. The means of making these changes in speed is derived by the device itself, not by a mechanical drive shaft. The said invention is much lighter and has fewer parts than previous designs.

### DESCRIPTION OF THE PREFERRED EMBODIMENT

The supporting device can be of many configurations as long as they transmit the unidirectional forces to the frame and to the attached vehicle. The axes of rotation provides for the rotation of the arms as well as providing passages for to travel from air from the axes to the orifices in the arms. The arms and their attachments are shown in drawings one, two and details on three. The air passages on the axes provides a means for the air to pass into one of the arms and to the orifice. Said orifice is directed so as to cause the arm to rotate in a clockwise direction. At the same time, the axes also directs air into the passages on the other arm to cause it to rotate in the anticlockwise direction. The exit of the air from the orifices in said arms cause the arms to accelerate in speed until the ducts to the arms are closed off by the change in position of the arms around the axes. The new position of the arm causes the air to flow to the orifices on the opposing side of the arms. This causes the arms to slow in their rotation until they reach a position where the rotation causes those ducts to close and the original duct to open. This cycle continues as long as there is air pressure in the device.

With respect to the above description, it should be realized that the optimum dimensional relationships for the parts of the invention, to include variations in size, materials, shape, form, function and manner of operation, assembly and use, are deemed readily apparent and obvious to those skilled in the art, and therefore, all relationships equivalent to those illustrated in the drawings and described in the specification are intended to be encompassed only by the scope of appended claims. The use of the word “air” is for simplicity of description. The arms of this invention could be propelled by any gas, steam or product of combustion or liquid that could flow through the orifices.

While the present invention has been shown in the drawings and fully described above with particularity and detail in connection with what is presently deemed to be the most practical and preferred embodiments of the invention, it will be apparent to those of ordinary skill in the art that many modifications thereof may be made without departing from the principles and concepts set forth herein. Hence, the proper scope of the present invention should be determined only by the broadest interpretation of the appended claims so as encompass all such modifications and equivalents.

### BRIEF DESCRIPTION OF DRAWINGS

Page 1 FIG. 1 is a side view of the arm showing the centre of rotation on the left and a weight on the right. Cross section AA is shown to the right of FIG. 1.

FIG. 2 is the cross section BB. The orifices are shown on the arm between the weight and the centre of rotation.

Page 2 FIG. 3 is a cross section of the arm indicating the air passages from the centre of rotation to the orifices.

FIG. 4 is of the axes showing the ducts through which the air passes into the arm.

FIG. 5 is the end view of the axes.

Page 3 FIGS. 6 and 7 represent two views of the frame with the axes in place.

FIG. 8 is a partial view of the arm and;

FIG. 9 shows two arms in position on the axes.

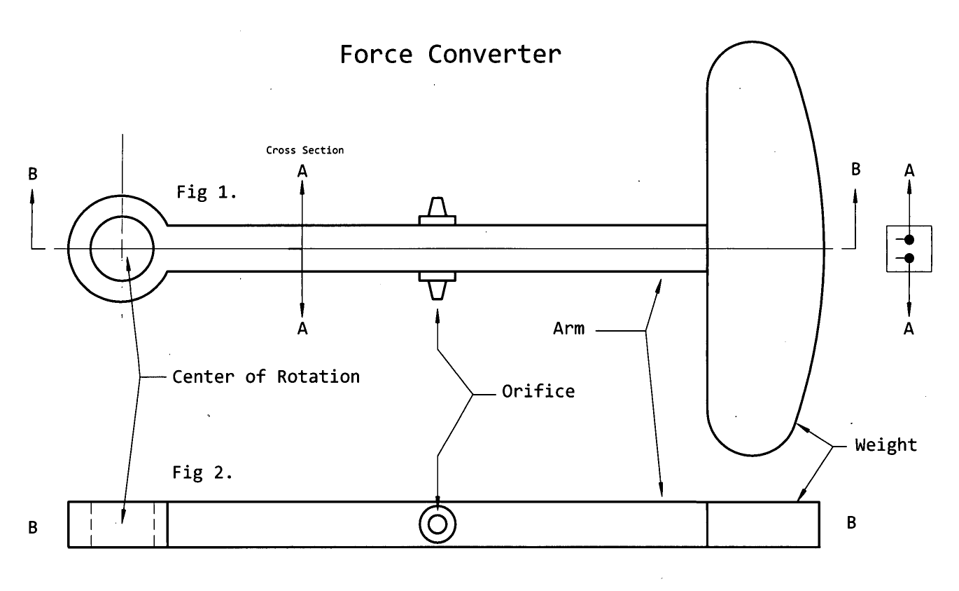

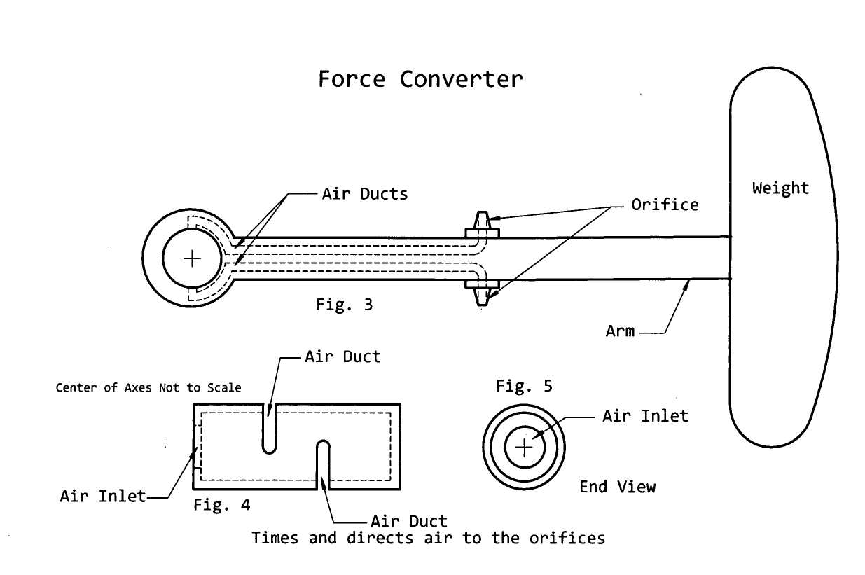

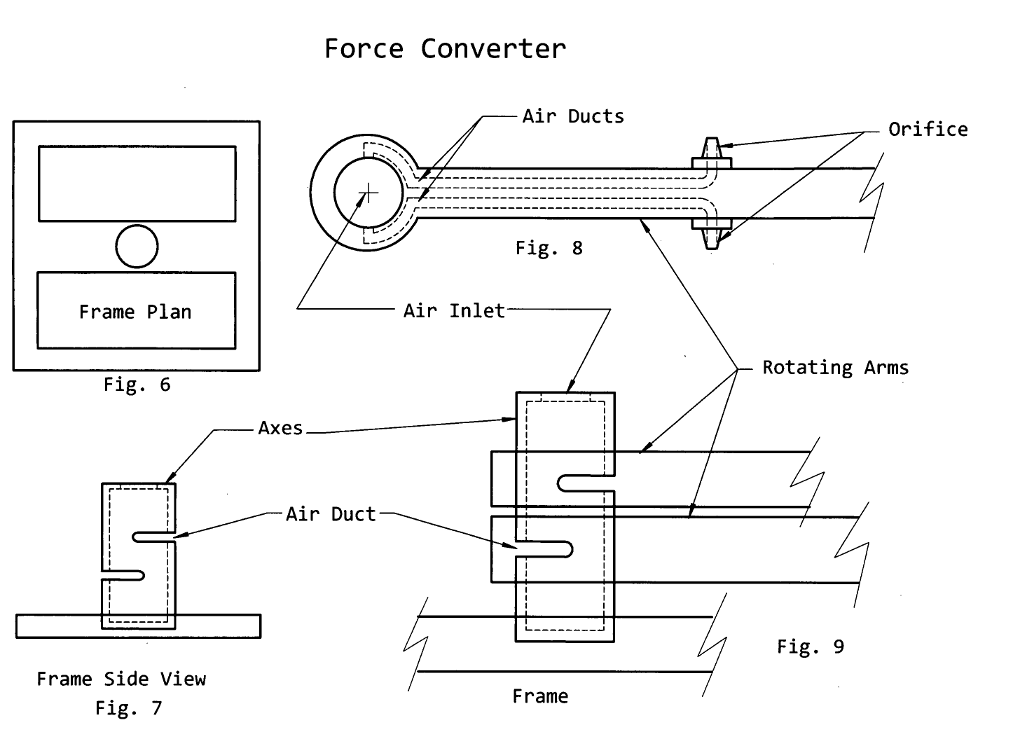

1. This device provides a means of converting rotary motion into a directional force by varying the speed of a plurality of masses and their supporting arms, counter rotating around a common center of axes

2. The device in claim 1 provides a means of varying the speed of the plurality of rotating masses counter rotating around a common center of axes.

3. The device in claim 2 provides a center of axes around which the plurality of masses rotate.

4. The device in claim 3 provides a means of propelling said rotating masses around the center of axes.

5. The device in claim 4 provides a means of fastening the said axes to a frame means for attaching to a vehicle.
